(19) United States
(12) Patent Application Publication
(10) Pub. No.: US 2006/0215245 A1
(43) Pub. Date: Sep. 28, 2006

(54) Light based computing

(76) Inventor: Gordon Scott Gehrs, Harwood Heights, IL (US)

Correspondence Address: FITCH EVEN TABIN AND FLANNERY, 120 SOUTH LA SALLE STREET, SUITE 1600, CHICAGO, IL, 60603-3406, US

(21) Appl. No.: 11/289,754

(22) Filed: Nov. 29, 2005

Related U.S. Application Data
(60) Provisional application No. 60/631,939, filed on Nov. 30, 2004.

(51) Int. Cl. G06E 3/00

(52) U.S. Cl. 359/107; 359/108

(57) ABSTRACT

Visible light frequencies are used as computational surrogates for values in a computational platform. Such light frequencies (each representing a corresponding arithmetic value, state, or the like) are combinable with one another to form corresponding resultant light frequencies wherein the value as corresponds to the resultant combined light frequency comprises a resultant as represents a corresponding computational operation (such as addition, subtraction, or the like).

### RELATED APPLICATIONS

This application claims the benefit of the filing date of U.S. Provisional Application 60/631,939 which is hereby incorporated in its entirety herein.

### FIELD OF THE INVENTION

This invention relates generally to computational platforms.

### BACKGROUND

Binary-based computing presently comprises an essentially ubiquitous architectural standard. This reflects, in large measure, the technological infrastructure used to embody present computational platforms; i.e., transistors. For the most part, for purposes of designing a computing engine, a transistor is either “on” or “off.” These two states serve to represent, accordingly, binary “1's” and “0's”

Significant improvements with respect to computing speed and sheer bulk of computational capacity has been achieved largely through miniaturization. That is, by making transistors smaller and smaller, more and more transistors can be used to support the sought-after computational increase.

There are concerns that, at some point, continued significant reductions in transistor size cannot be achieved.

### BRIEF DESCRIPTION OF THE DRAWINGS

The above needs are at least partially met through provision of the light based computing method described in the following detailed description, particularly when studied in conjunction with the drawings, wherein:

FIG. 1 comprises a diagram of the signal makeup. Each light beam would operate on a different frequency, i.e. 560 nm in wavelength for one, 680 for another, which is one way to measure the base of the calculations.

FIG. 2 comprises a figure that basically shows how the light frequencies could be manipulated in different ways for timing, and so forth.

FIG. 3 shows how the light grid could be laid out to have discreet frequency states along the top—01, 02, 03—and how they might be modified by alternate signal shifts—s1, s2, s3—and so forth.

FIG. 4 presents the signal matrix at different times—T1, T2, T3, T4—and illustrates how the resultant signals could change representing, say, the number 20083 at time T1, and the alpha-numeric combination “Hello world I'm 38” at another time T2, and so forth.

FIG. 5 presents a matrix that could be used as a building block to represent, for example, different multipliers for different computing bases, i.e. Binary, Trinary, Hex and so forth. The Base, Multiplier, Level, and Operator would basically allow one to say, this number is in base 10, the multiplier is 1000, so now we have the number 1000, the level could then set the next number, say 478, now the Operator would say what we do with those two numbers (i.e., multiply, divide, etc.). If the operator were addition, say frequency 600 nm, then the resultant signal means 1478, while if the Operator is subtraction, say 610 nm frequency, then the number resultant is 522.

FIG. 6 shows that one could basically reserve certain sections for certain operations, Array operations, Operating System areas, and so forth. This would allow one to incorporate all previous computing requirements in the area of data types, array operations, command-level functions, etc. so that the system would be able to read and understand any computer system installed on it. Additional areas could be left open for future upgrades and so on.

FIG. 7 depicts an area where one could reserve certain operational elements like reading from and writing to operating system level variables, holding memory arrays for system calculations, etc.

FIG. 8 depicts an area that could be reserved for the logical, arithmetic, and data typing operations; this could be preset or calculated on the fly based on the arithmetic base that was being used.

FIG. 9 shows how the signal matrix could be laid out in 2 dimensions. Layer 1 would hold the base number and the shift, i.e. what we are doing to the number. Then the carry could hold this value—the right side of FIG. 9—taking signal Green and Infra-Red #2 and multiplying them, to get the number 550.

FIG. 10 shows how the signal matrixes could be stacked to then perform actual calculations; say stack 1 has a computed value of 550 and stack 2 has a computed value that is multiplication, the resulting number is 5500. Or, the signal matrixes could simply have place values given their arithmetic base, say a stack 1 is the 1's and stack 2 is the ten's and stack 8 is the billion's place, a signal lattice of orange in the billion's place might mean 2 billion, and a red the 1's place might mean 1, so the resulting number would be 2 billion and 1.

FIG. 11 shows how the computational matrixes could be extended to the limits of physical architecture allowing the system to expand well beyond the limits described herein.

FIG. 12 depicts a grid to dynamically alllow the system of numbers to expand based on an input multiplier.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DESCRIPTION

These needs and others are substantially met through provision of a light-based computational platform. As is known in the art, the visible spectrum of light extends from the color red through violet. Pursuant to these teachings, different colors of light are used to represent discrete numerical quantities as well as various operands and computational results. Various mechanisms exist to both source and detect light of different frequencies and these mechanisms can be employed to embody these teachings.

Numerous benefits can be expected. By using a number of colors beyond two, the computational base can be readily extended beyond the binary paradigm that characterizes the bulk of today's computing platforms. Further, electrical signals often traverse an existing transistor-based platform at a speed that is considerably less than the speed of photons that comprise light. Light-based computing may also be considerably less sensitive to other phenomena, such as impedance issues, electromagnetic field distortion, and so forth that can degrade or stymie present day computing.

All computers in the world run on the electrical and binary signal method; i.e. the signal is off or on and a binary number representation is what makes the computer, via logic gates and the like, able to do one thing—add numbers. Such a computer runs on electrical signals which are ⅓ as fast as photons that make up light. Electricity is also subject to significant physical problems such as impedance, electromagnetic field distortion, and so forth.

These teachings avoid as least some of these problems through provision of an optical cable matrix-based processor core. This can comprise, for example, 1,000 light emitting fibers on one side of a chip, and 1,000 on another side of that chip (those skilled in the art will readily understand and appreciate that these values are for purposes of illustration only and are not to be taken as being limiting in any sense). Such a matrix will enable a total of 1,000,000 different signal intermixes. When employing such a matrix in conjunction with different frequencies of light, the resultant interactions of light will produce an extremely large calculation base. Instead of base 2 or binary, for example, one can have a numeric base of as many discrete light signals as is possibly discernable.

This illustrative matrix of 1,000×1,000 incoming/outgoing light fibers can be configured three dimensionally; i.e., a third z-plane set of 1,000 light fibers can be combined with the foregoing 2-dimensional matrix. This in turn will yield a signal lattice that comprises a calculation platform, or temporary logic space, of 1,000×1,000×1,000, thereby providing capacity and capability to potentially run calculations at a rate of trillions or more per second. Any additional benefit accrues with respect to rate, of course, because such an apparatus is capable of processing at the speed of light instead of electricity which, as has already been noted above, in practice considerably lags the speed of light.

To provide for memory, such as random access memory (RAM), a section of this computer can take the signal output from the matrix or lattice processor and send it out into a small, temporary area where the light impinges upon a material that allows the corresponding light frequency to remain steady for at least short periods of time to thereby render it available to be used in further calculations. This material is preferably such that it can retain the signal from the lattice until or unless there is an external stimuli that allows or causes it to lose its light retaining properties.

Bioluminescent animals and plants employ a related chemical process and those skilled in those arts will recognize that it is a relatively simple process to emulate. Two primary chemicals are typically employed. One which produces the light is generically called a luciferin and the one that drives or catalyzes the reaction is called a luciferase. The luciferase catalyzes the oxidation of luciferin resulting in light and an inactive oxyluciferin. In most cases, fresh luciferin must be brought into the system to support continuation of the process. Such techniques are readily employed to provide a RAM capability that is responsive to light and that serves to store, at least for brief periods of time, light.

A permanent storage system can comprise, for example, a re-writable digital video disc (DVD) drive which can be used to allow for hard drive optical reads and writes.

Accordingly, a computer that runs on the light signals of the color spectrum would be both simple to build and extremely fast during operation. Consider an example using the colors Red, Green, and Blue (this is just for ease of discussion and simplicity in presentation; those skilled in the art will recognize that such a matrix-based processor could be readily expanded to encompass the entirety of the visible (or near visible) electro-magnetic spectrum in discrete, measurable frequencies). Using Red, Green, and Blue, one can calculate numbers using base 4, or hexadecimal, or any other numeric base desired. In hexadecimal for example, the number 0 could be represented by an absence of colors. Red could then represent a 1, Green a 2, Blue a 3, Red and Green together a 4, and Red and Blue a 5.

This color combination could be readily extrapolated to create a computational base of billions of combinations when set into 2, 3, or more dimensions. Using the intersection of photon beams, there could be trillions of combinations available for each signal flip-flop. This would be far faster than conventional architecture as the machine would use light, and would only be limited in its computational base by the factor of how many discrete frequencies could be measured.

Referring now to FIG. 1, by one approach such a light driven computer processor can use a highly refractive multi-polygon prism 10, as it will create all of the visible colors depending on which way it is turned. Such a device that can be readily manipulated to create the color signals 11 for the processor which are then fed to the aforementioned fibers 12.

Using the known spectrum of light frequencies 13, one can construct a computer that conceivably operates on an essentially infinite number of combinations to create instructions, all at the speed of light. The matrix could be as simple as assigning each frequency a numeric value, i.e. no light could be a zero value, low infrared could be a 1 all the way up to high ultraviolet which could be say, a value of 1000. Using this system, one can make calculations far faster and with a far greater range than, say, a binary system using electricity.

By one approach the logic gates used to control the flow of the photons could be powered by electromagnetic fields set up to divert the photon stream.

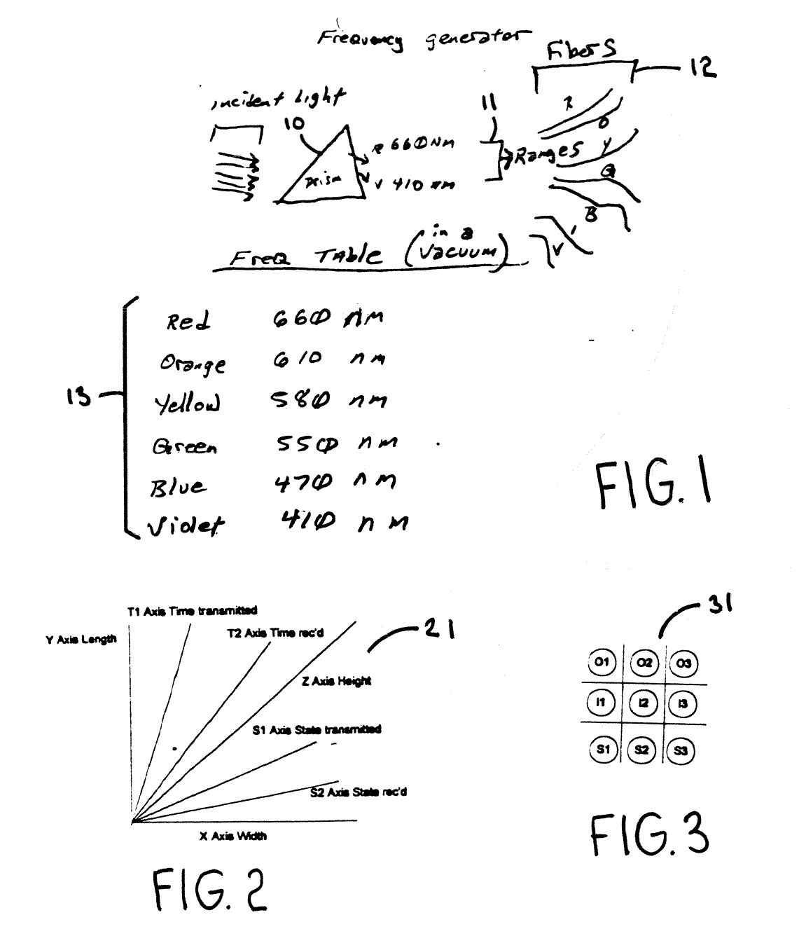

With reference to FIG. 2, and for purposes of illustration, one can work with such signals in 7 dimensions 21. 3 (the X, Y, and Z axis) govern where in the matrix the signal lies, T1 governs at which point in a clock-cycle the signal is transmitted, T2 governs when a signal is received, S1 governs which state the signal is in when transmitted, and S2 when received. FIG. 2, of course, comprises a two-dimensional rendering of how the matrix could be enlarged or expanded to move into three dimensions and beyond (where, for example, the Y and X axes could represent different colors that converge at a different time).

There may be, for example, a different time that a signal is received and/or a different state in which it was received. For example, the matrix may be configured and arranged for addition, multiplication, subtraction, modulus, and/or other arithmetic manipulations of choice. Essentially, as shown, one may work with such signals in seven different dimensions where three of the dimensions govern where the matrix and the signal lies. To illustrate, T1 could govern the time on the clock when the signal is transmitted, T2 could govern when the signal is received, SI could govern the corresponding state, and so forth.

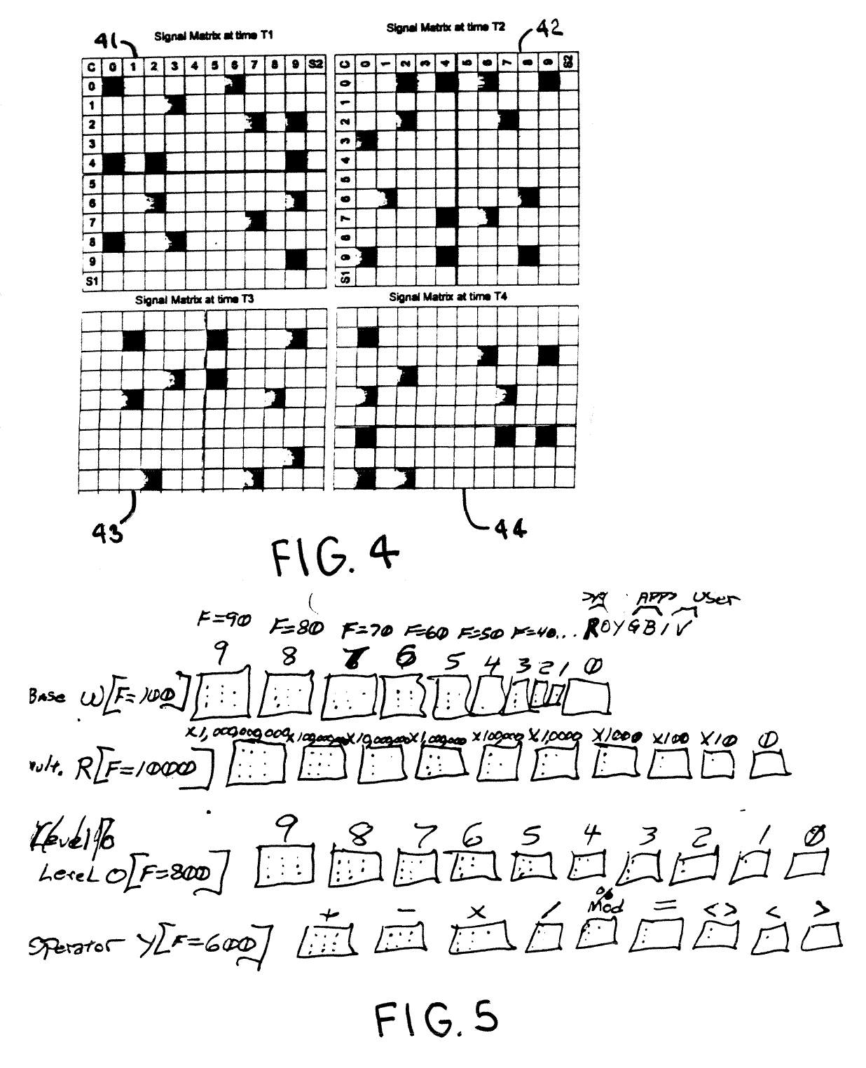

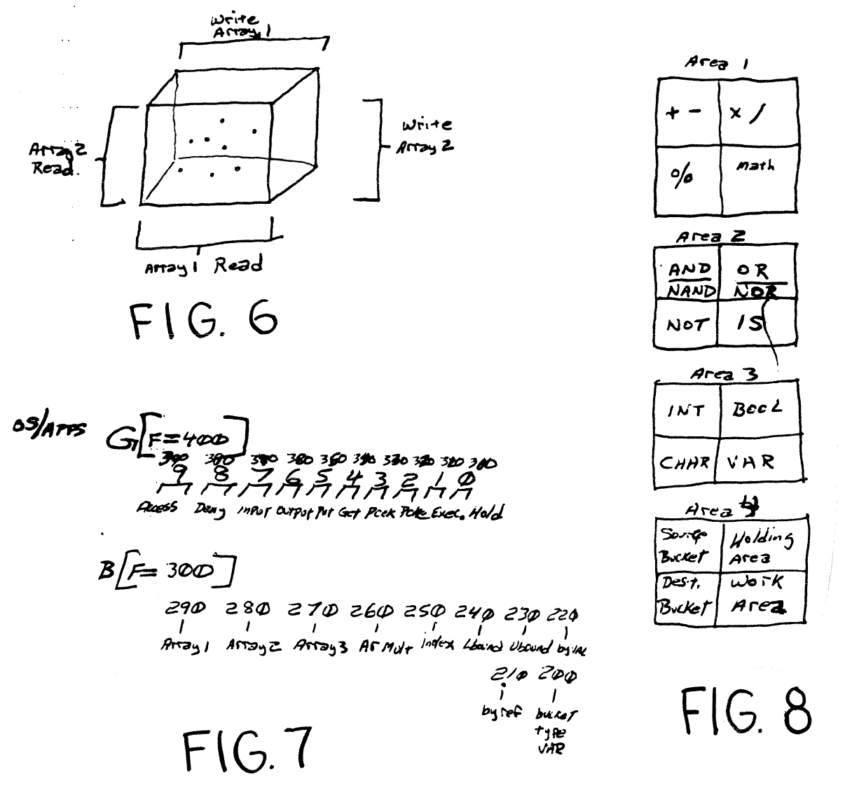

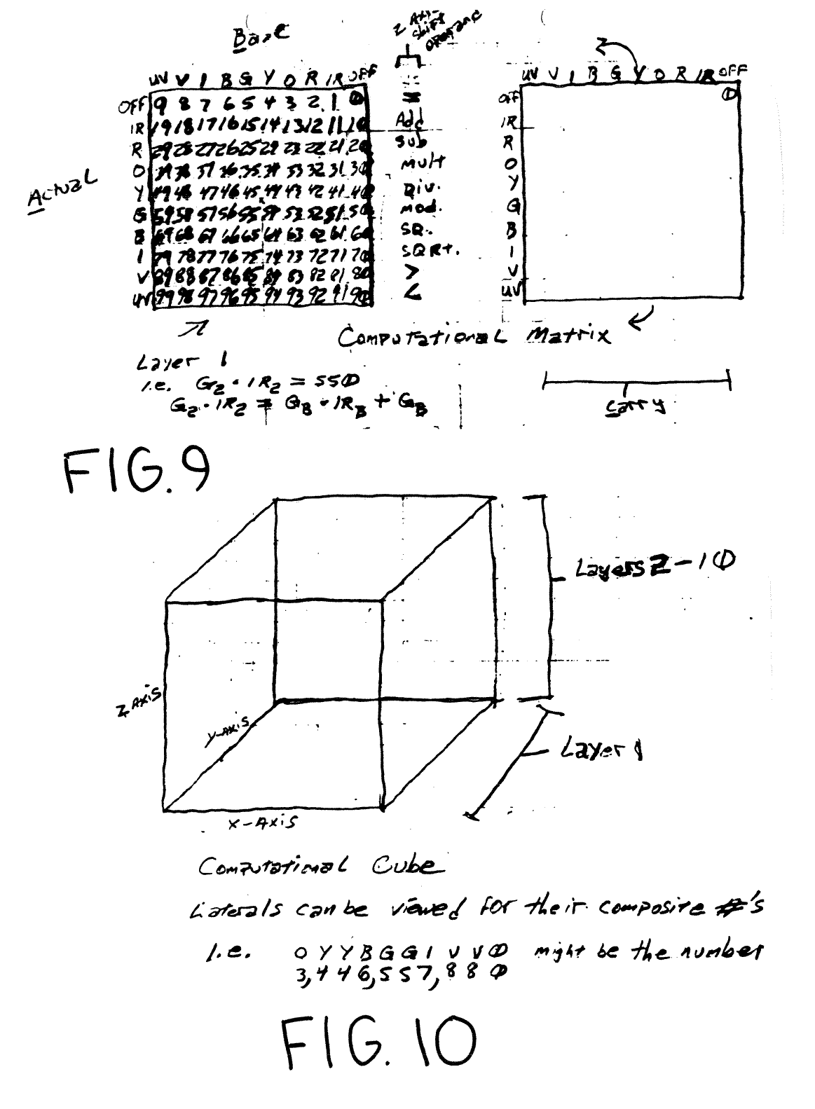

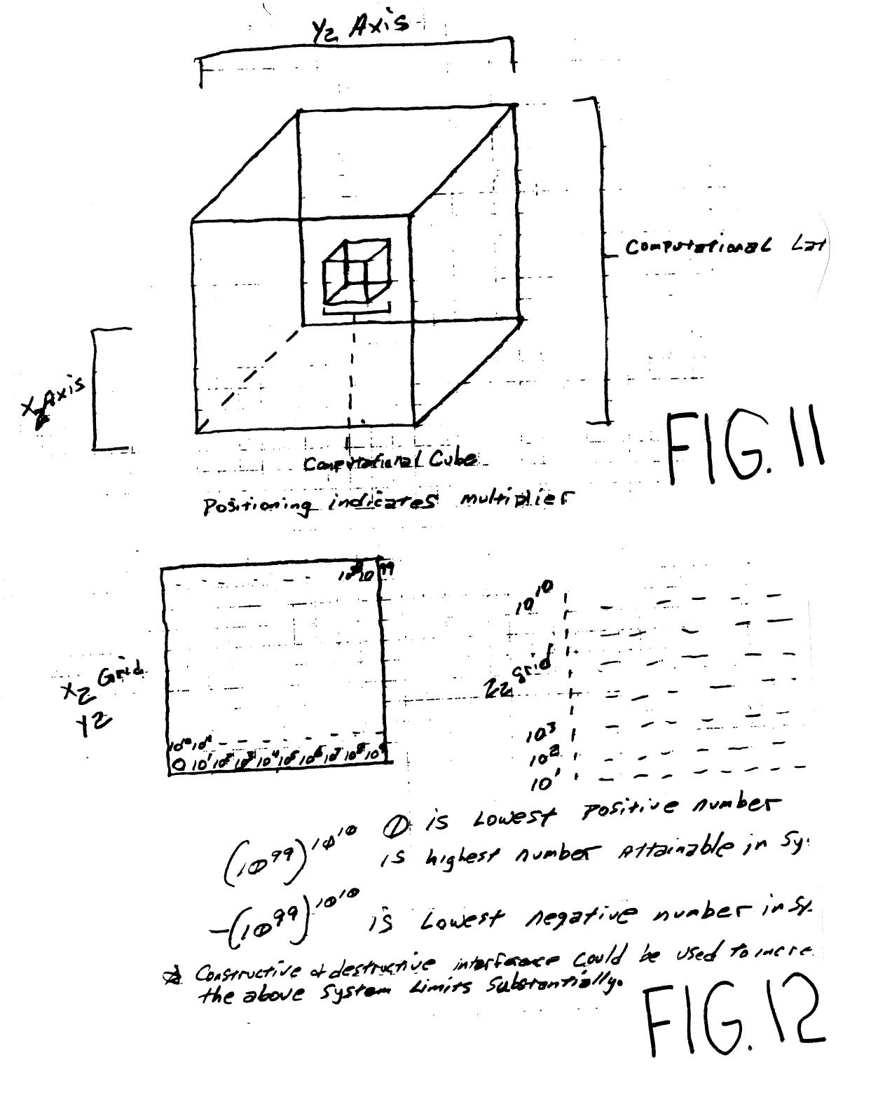

Corresponding AND/OR Gates provide the potential to compute numbers purely by addition alone. Subtraction can be accomplished computed by adding negative numbers. Referring now to FIG. 3, a light-based gate 31 provides the opportunity to mix signals of differing frequencies to achieve addition, subtraction, multiplication, division, modulus, and trigonometric functions with one gate.

From the bottom up—S1, S2 S3 are discrete States (i.e., light frequencies), I1, I2, I3 are discrete interference signals, and O1, O2, O3 are the outputs from the confluence of each Sx when paired with it's Ix. As depicted, FIG. 3 essentially illustrates a gate that permits shifting to and from different states and that allows one to make signals of different light frequencies to achieve results such as addition, subtraction, multiplication, division, modulus, and trigonometric functions without necessarily requiring recourse to additional gates or components. To illustrate, red, orange, yellow, green, blue, indigo, violet, off, and infra red could be used in this manner and, when combined in various ways, could signal via their composite aggregate frequency a particular computational configuration (such as addition, subtraction, or the like).

FIG. 4 provides a depiction of a representative signal matrix at first time T1 41, a second time T2 42, a third time T3 43, and a fourth time T4 44. In this depictions, C=Control Signal for Matrix Level being used, 0-3; S1=State of level when signal is sent to level S2; S2=State of level when signal is received at level S1 (S2 can also be used to indicate where the remainder of the signal string is to be found, i.e. up a level or down).

I claim:

1. A method comprising:
assigning each of a plurality of visible light frequencies a corresponding numeric value;
providing in a light-based computer at least a first visible light signal having a first one of the plurality of visible light frequencies;
providing in the light-based computer at least a second visible light signal having a second one of the plurality of visible light frequencies;
combining in the light-based computer the first and second visible light signals to provide a resultant visible light signal having a corresponding visible light frequency;
using, in the light-based computer, a numeric value as corresponds to the visible light frequency for the resultant visible light signal.
